(19) United States
(12) Patent Application Publication
(10) Pub. No.: US 2006/0258378 A1
(43) Pub. Date: Nov. 16, 2006

(54) Mobile device for mapping sms characters to e.g. sound, vibration, or graphical effects

(76) Inventor: Terho Kaikuranata, Piispanristi (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/561,305

(22) PCT Filed: Jun. 20, 2003
(86) PCT No.: PCT/IB03/02403

§ 371 Date: Dec. 19, 2005

(51) Int. Cl. H04Q 7/20

(52) U.S. Cl. 455/466

(57) ABSTRACT

The invention relates to a device for perceivably accentuating message elements of a message, wherein the message is composed of message elements chosen from a limited set of message elements, the device having elements: for defining and/or altering a set of Selected Message Elements (SMEs) containing at least one SME, wherein each SME is a message element from the limited set of message elements; for assigning a Perceivable Accentuation Signal (PAS) from a set of PASs to each of the SMEs in the set of SMEs; for searching the message for SMEs of the set of SMEs; and for generating the assigned PAS for each SME found in the message. The invention further relates to a method and a computer program product for the perceivable accentuation of message elements of a message.

### FIELD OF THE INVENTION

The invention relates to a device for perceivably accentuating message elements of a message, wherein said message is composed of message elements chosen from a limited set of message elements, the device comprising: means for defining and/or altering a set of Selected Message Elements (SMEs) containing at least one SME, wherein each SME is a message element from said limited set of message elements; means for assigning a Perceivable Accentuation Signal (PAS) from a set of PASs to each of said SMEs in said set of SMEs; means for searching said message for SMEs of said set of SMEs; and means for generating the assigned PAS for each SME found in said message. The invention further relates to a method and a computer program product for the perceivable accentuation of message elements of a message.

### BACKGROUND OF THE INVENTION

The Short Message Service (SMS) is a service for sending text messages of a limited number of characters to mobile phones that are for instance operated according to the Global System for Mobile Communication (GSM) standard or the forthcoming Universal Mobile Telecommunications (UMTS) standard. SMS is similar to paging. However, SMS messages do not require the mobile phone to be active and within range and will be held for a number of days until the phone is active and within range. SMS messages are transmitted within the same cell or to anyone with roaming service capability. They can also be sent to digital phones from a Web site equipped with PC Link or from one digital phone to another. Typical uses of SMS include notifying a mobile phone owner of a voice-mail message, notifying a salesperson of a contact to call, notifying a doctor of a patient with an emergency problem, etc. The SMS messages can be stored on the mobile phone and are usually presented for reading on the display of the mobile phone.

To enhance the information portrayal of SMS messages on mobile phones, techniques such as haptic messaging have been developed. Haptic messaging means SMS-based messaging, where part of the SMS message includes elements like a smiley, e.g. 8) or ;) or :(, that associate vibration at the receiving mobile phone.

Haptic actuators are known from PC and console game controls, e.g. as force feed-back. Further application fields are vehicle controls, surgical telemanipulators, aircraft controls (stall alert on control stick/wheel) and cars, e.g. the BMW iDrive in the 700-series. Haptic actuation is thus a well established technique in human-machine interaction, which, with further decreasing actuator sizes, also becomes applicable for handheld consumer products.

It is generally known that special characters, symbols, icons or a smiley can be defined to mark specific vibration patters that are transferred as text via the SMS protocol to the receiving mobile phone, where vibration motors or specific haptic actuators are used to create vibrations together with the text. This enhances and highlights the SMS message without requiring a new type of message format, as it is e.g. the case with the MIDI standard for audio messaging.

However, problems arise when sending haptic content over the network or otherwise directly between separate devices is to be implemented. Said direct transmission means might include a Bluetooth connection, an infrared data link, a cable connection or any other method capable of similar transmission functionality. Due to different haptic capabilities of the mobile phones fabricated by different manufacturers, haptic messaging is hard to standardise. Standardisation of haptic messaging via SMS would require to prescribe the haptic effects each mobile phone has to be able to generate as well as to define the elements (words) of an SMS message that force these haptic effects at the mobile phone that receives the SMS message. Factors inhibiting standardisation of haptic messaging are related to the question of how to enter and manage haptic data at the transmission side, especially with respect to the user interface of a mobile phone, how to achieve downward compatibility with older mobile phones on the reception side, especially if special characters are used in a text message to define specific haptic effects which are not available at said mobile phone and thus irritate the user, and how to ensure that all features of future mobile phones that are developed by different manufacturers are covered by such a standard. Lack of standardisation so far has blocked the introduction of haptic messaging.

### SUMMARY OF THE INVENTION

Setting out from the above-mentioned problems encountered in the application field of haptic messaging, it is thus the general object of the invention to provide a device and method for perceivably accentuating message elements of a message without requiring any standardisation of perceivably accentuated messaging.

The object of the invention is solved by proposing a device for perceivably accentuating message elements of a message, wherein said message is composed of message elements chosen from a limited set of message elements, the device comprising: means for defining and/or altering a set of Selected Message Elements (SMEs) containing at least one SME, wherein each SME is a message element from said limited set of message elements; means for assigning a Perceivable Accentuation Signal (PAS) from a set of PASs to each of said SMEs in said set of SMEs; means for searching said message for SMEs of said set of SMEs; and means for generating the assigned PAS for each SME found in said message. With the help of the device according to the present invention, which may for instance be a part of a mobile phone device and/or any device that can be controlled with SMS commands, wherein both devices are capable of rendering an SMS message that consists of message elements (e.g. characters) of a limited set of message elements (e.g. the ASCII alphabet), a user thus has the possibility to define a set of SMES, e.g. a set of key words, and to assign each SME in said set of SMEs a PAS, e.g. a certain sound. The same PAS may be assigned to a plurality of SMES. When a message is rendered, a means in the device searches for the SMEs and, for each found SME, a further means in said device generates the PAS that has been assigned to said SME. The fact that no standardisation of perceivably accentuated messaging is required is reflected by the possibility of the user of said device to define the set of SMEs (and the assigned PASs) by himself or, if a set of SMEs and assigned PASs has already been provided by the manufacturer of the device as a proposal, to alter said set of SMEs (and the assigned PASs). It is understood that the device then has to offer means for the display and manipulation of said set of SMEs and the assigned PASs. Due to the lack of standardisation, the composer of a message can not force the generation of PASs by said device during the rendering of his message, because he does not know the set of SMEs that is used by the user of said device. In general, this keeps the composed messages free of message elements that have no meaning in the context format of the message, but only serve as SME to cause a PAS at the device according to the present invention. However, if the composer of the message knows the type of device the PASs are generated by, and further knows that the user of said device did not or only insignificantly alter the set of SMEs that has been provided in said device by the manufacturer, forcing the generation of PASs by said device during rendering of the message is possible. The present invention thus has the potential of establishing a device-specific or manufacturer-specific pseudo-standard for perceivably accentuated messaging, if most of the users do not or only insignificantly alter the set of SMEs and the assigned PASs, e.g. by only adding further SMEs and assigned PASs to a set of SMEs that was provided by the manufacturer of said device. It should be noted that the type of message is of minor importance for the present invention, as long as message elements can be identified in the message and used to define a set of SMEs. It is thus possible to use the invention for text messages such as SMS-based messages on mobile phones or electronic messages on a computer, but also for spoken messages (like news rendered on a car radio), modulated signals, etc. However, the complexity of the means for defining the set of SMEs and the means for searching the message for said SMEs then may vastly increase.

The entire functionality of defining SMEs, searching a message for SMEs and generating the PASs is only required at the receiver, not at the transmitter/sender. This is considered as one of the main advantages of the present invention.

The present invention has the further advantage that the original messaging format is not modified, i.e. all modifications refer to the device according to the present invention without affecting the process of composing and rendering the message. In the message, thus no special characters are required to define a certain vibration profile, so that the message written in the original messaging format remains comprehensible even if it is rendered on an apparatus that does not support perceivably accentuated messaging. As a natural further consequence, no changes are required at the device on which the message is composed.

Integrating the device according to the present invention into the device that renders the message requires only minor extensions of the software and/or operating system, so that the message can be searched and so that the set of SMEs and assigned PASs can be defined and managed. The present invention thus allows to introduce perceivably accentuated messaging to the market with low market risk, because only new devices are equipped with the feature of perceivably accentuating messages without affecting or influencing the other devices. However, offering the feature of perceivably accentuating messages in their devices may strongly differentiate manufacturers from their competitors.

According to the device of the present invention, said set of PASs preferrably comprises optically and/or acoustically and/or haptically and/or olfactorily and/or thermally and/or electrically PASs. Thus the full range of perceivable effects that can be offered by an electronic device is available, e.g. flashing of the devices lights, changing the display colour, displaying icons on the display, flashing key words on the display, generating all kinds of sounds, especially the sounds that are already programmed in the device to indicate certain states of the device such as error sounds, vibrating, generating scents, varying the temperature and generating electric shocks of small power.

According to the device of the present invention, said PASs in said set of PASs preferrably have different signal characteristics such as amplitudes and/or frequencies and/or durations and/or signal forms. A huge variety of acoustically PASs can for instance be achieved by varying the frequency or duration of a standard sine tone.

According to the device of the present invention, it is preferred that said message is a text message, that said message elements are characters or combinations thereof and that said means for searching said message for SMEs of said set of SMEs comprises a parser. In a text message, said SMEs thus may represent single characters like exclamation or question marks, or words, or combination of words or even whole sentences. The definition of PASs for SMEs of a text message is most intuitive and easy to achieve.

According to the device of the present invention, it is advantageous that said set of SMEs and information on the PASs assigned to each SME in said set of SMEs are stored in said device. Efficient storage of the set of SMEs and the assigned PASs might be accomplished by a tabular, where the first column contains the SMEs and the second column contains the PAS assigned to each SME. Entries in the tabular may be grouped according to criteria related to the SMEs (topics like “love”, “fun”, “work”, etc.) or PASs (“vibrating”, “sound”, “light”). Said tabular is preferably stored in a RAM of the device or, if transfer to other devices is desired, on a storage medium that can be removed from the device, such as a flash card or the Subscriber Identity Module (SIM) card of a mobile phone. Naturally, for the purpose of tabular transfer to another device any available means can be used, e.g. a Bluetooth connection, an infrared link, a cable connection, etc.

According to the device of the present invention, it is preferred that said means for generating the assigned PAS for each SME found in said message comprises means for generating said assigned PASs for each SME found in the message sequentially and synchronised with the rendering velocity of the message and/or synchronised with the message perception velocity of the user of said device. The PASs should be perceived by the user of the device in the instant when the SMEs it is assigned to is presented to or perceived by the user, where the message may either be rendered by said device or by a different device (then both devices are most likely integrated in one apparatus). This, as a basis, requires that the PASs are generated in the sequence the SMEs they are assigned to appear in the message. Furthermore, when the means for searching the message for SMEs has processed the message, it may be imagined that each PAS that has to be generated, because the SME it has been assigned to was found in the message, is assigned a certain delay that depends on the position of the SME in the message, so that its generation is synchronised with the perception of the corresponding SME in the message by the user. To determine the required delay, said means in said device requires information on the perception velocity of the user, which may be entered manually by the user of the device or the manufacturer.

According to the device of the present invention, said device further advantageously comprises means for determining the message perception velocity of the user of said device. By measuring the time a user requires to perceive a message and comparing it with the number of message elements in said message, said device may for instance determine an average message perception velocity of said user. Average message perception velocities may be determined from information that is made available by the device that renders the message, which may either be the device according to the present invention or a different device, and may comprise the perception time per message and the number of characters or words per message.

According to the device of the present invention, said device is preferably contained in a mobile phone that is operable in a mobile communications system and said message is preferably a message in the format of the Short Message Service (SMS). Each device that is capable of receiving SMS messages or to be controlled by SMS messages is understood as a mobile phone in this context.

According to the device of the present invention, said device further preferably is contained in a computer and said message is preferably an electronic mail (e-mail) message.

The object of the invention is further solved by proposing a method for the perceivable accentuation of message elements of a message, wherein said message is composed of message elements chosen from a limited set of message elements, comprising the following steps: defining and/or altering a set of Selected Message Elements (SMEs) containing at least one SEM, wherein each SME is a message element from said limited set of message elements and is assigned a Perceivable Accentuation Signal (PAS) from a set of PASs; searching said message for SMEs of said set of SMEs, and generating the assigned PAS for each SME found in the message. The step of defining a set of SMEs may be performed by the manufacturer of the device the method is used on or by the user of the method, whereas the step of altering said set of SMEs is preferably performed by the user of said method.

According to the method of the present invention, it is preferred that said set of PASs comprises optically and/or acoustically and/or haptically and/or olfactorily and/or thermally and/or electrically PASs.

According to the method of the present invention, it is preferred that said PASs in said set of PASs have different signal characteristics such as amplitudes and/or frequencies and/or durations and/or signal forms.

According to the method of the present invention, it is preferred that said message is a text message, that said message elements are characters or combinations thereof and that said step of searching said message for SMEs of said set of SMEs comprises the step of parsing said message.

According to the method of the present invention, it is preferred that said set of SMEs and information on the PASs assigned to each SME in said set of SMEs are stored.

According to the method of the present invention, it is preferred that said assigned PASs for each SME found in the message are generated sequentially and synchronised with the rendering velocity of the message and/or synchronised with the message perception velocity of the user of said method.

According to the method of the present invention, it is preferred that the method further comprises the step of determining the message perception velocity of the user of said method.

The object of the invention is further solved by a computer program product directly loadable into the internal memory of a digital computer, comprising software code portions for performing the above-mentioned method steps when said product is run on a computer. The digital computer may for instance be the processor that runs the operating system of a mobile phone or computer.

### BRIEF DESCRIPTION OF THE DRAWINGS

These and other aspects of the invention will be apparent from and elucidated with reference to the embodiments described hereinafter. In the figures show:

FIG. 1: A schematic block diagram of a device for perceivably accentuating message elements of a message according to the present invention.

### DETAILED DESCRIPTION OF THE INVENTION

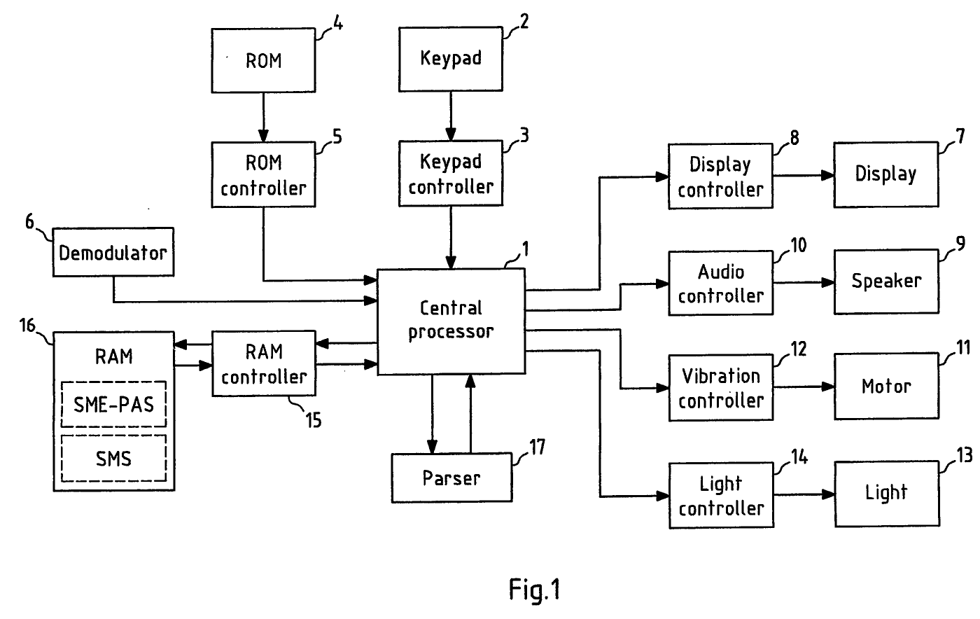

FIG. 1 depicts a schematic block diagram of a device for perceivably accentuating message elements of a message according to the present invention. The device comprises a central processor 1 that is capable of controlling all functionality related to the management and generation of Perceivable Accentuation Signals (PASs). The device further comprises functionality to render messages. The device in FIG. 1 thus may be imagined to be contained in a mobile phone, where SMS messages can be rendered and perceivably accentuated, e.g. the Nokia 6800 mobile phone, which has a colour screen and MMS capability. When the phone is flipped open, a full keyboard for writing text messages and emails quickly and easily is available. If the present invention targets at haptic messaging, the device of the present invention can be imagined as “haptic effect receiver”, which can easily be integrated into mobile phones like the Nokia 6800.

The device receives input from a keypad 2 via a keypad controller 3, from a ROM 4 via a ROM controller 5, from a demodulator 6, and controls a display 7 via a display controller 8, a speaker 9 via an audio controller 10, a vibration motor 11 via a vibration controller 12 and a light 13 via a light controller 14. The central processor 1 further is connected to a RAM controller 15 that allows to read data in and write data out of a RAM 16. Finally, the central processor can input data into a parser 17 and receive the output signals of that parser 17. The flash-type of memory technology that can be reprogrammed electronically but that otherwise operates as a typical ROM memory can be considered in this description to be synonymous and to serve the very same purpose without separate notice.

In order to allow the perceivable accentuation of elements of an SMS message received and rendered on the mobile phone, the user of the mobile phone first has to define a set of Selected Message Elements (SMEs) and to assign each SME a PAS that can be generated by the mobile phone. In this example, where the message is an SMS text message whose message elements (characters) are taken from the limited ASCII alphabet with 128 characters, the SMEs are simply characters or combinations of characters. The PASs that can be generated on the mobile phone are stored in ROM 4, for instance in the following manner:

CONTENTS OF ROM 4

| | |
|---|---|
| PAS1: | sound, low |
| PAS2: | sound, high |
| PAS3: | vibration, short |
| PAS4: | vibration, long |
| PAS5: | light, flashing 3 times |
| PAS6: | light, static, short duration |
| PAS7: | light, static, long duration |
| PAS8: | display background, flashing 3 times |
| PAS9: | display background, static |

The step of defining the set of SMEs and assigning each SME a PAS is controlled by the central processor 1. By pressing buttons on the keypad 2 and following the instructions presented on the display 7, the user is guided through a menu that allows him to enter SMEs and to assign each SME a PAS. For each entered SME, the available PASs as contained in the ROM 4 are presented on the display 7 so that the user can select one PAS by using number buttons or arrow buttons on the keypad 2. After the user has confirmed his inputs, each SME of the set of SMEs and its assigned PASs is stored by the central processor 1 in a SME-PAS section of the RAM 16 via the RAM controller 15. The set of SMEs with assigned PASs may for instance look like:

CONTENT OF SME-PAS SECTION OF RAM 16

| | | | |
|---|---|---|---|
| SME1: | :( | causes | PAS1 |
| SME2: | :) | causes | PAS2 |
| SME3: | ! | causes | PAS4 |
| SME4: | ? | causes | PAS5 |
| SME5: | Heli | causes | PAS8 |

The mobile phone is then ready to render SMS messages and to accentuate the SMEs with PAS as defined in the SME-PAS section of RAM 16. Various other ways to present similar assignments could be made, such as a graphical association of SMA and PAS, e.g. with icons or flow chart type graphical presentations.

A standard SMS message now can be composed on an arbitrary mobile phone or computer and sent to the mobile phone that contains a device as depicted in FIG. 1. The composer of the SMS is not aware that the text of his SMS is parsed on the receiving mobile phone. When the SMS is received by the mobile phone that contains the device of FIG. 1, the demodulator 6 forwards the message that has been received as an RF signal via an antenna and accordingly filtered, down-converted, demodulated and decoded to retrieve the original message format (functionality that has been completely combined into the demodulator 6), to the central processor 1, that may for instance store the SMS in an SMS section in RAM 16. The text body of the stored SMS message may look like:

CONTENT OF SMS SECTION OF RAM 16

Congratulations !
Feeling old now ? :)
Missing you, Heli

When the user wants to read the SMS message, the central processor 1 reads out the SMS data from the SMS section of RAM 16 and the set of SMEs and the assigned PASs from the SME-PAS section of RAM 16 via the RAM controller 15 and inputs this data into the parser 17. The parser 17 searches the SMS message for the SMEs and internally generates a list that may look like:

LIST INTERNALLY GENERATED BY PARSER 17

| | |
|---|---|
| SME3 | found after 16 characters |
| SME4 | found after 34 characters |
| SME2 | found after 36 characters |
| SME5 | found after 52 characters |

Based on statistic information on how long the reading of SMS messages takes the user of the mobile phone, which is determined by the central processor 1 for each SMS read by the user, and on the set of SMEs and assigned PASs, the parser 17 translates the internally generated list into a list that is output to the central processor 1. This list may look like:

LIST OUTPUT BY THE PARSER 17

Generate PAS4 after 1.6 s
Generate PAS5 after 3.4 s
Generate PAS2 after 3.6 s
Generate PAS8 after 5.4 s

The central processor 1 now uses the display processor 8 to present the user the SMS message on display 7 and uses the commands as output by parser 17 to generate the required PAS synchronised with the visual perception of the SMS by the user via the display 7. In particular, the central processor 1 triggers the vibration controller 12 to generate a long vibration 1.6 s after the beginning of the presentation of the SMS on the display 7, triggers the light controller 14 to flash the light 13 three times after 3.4 s, triggers the sound controller 10 to generate a high sound with speaker 10 after 3.6 s and triggers the display controller 8 to flash the background of the display 7 three times after 5.4 s. The SMEs in the SMS message thus have been perceivably accentuated. If there is a need to use multiple display pages to present a message, the delay function can be adjusted to take this into account, so that the fundamental meaning of the proper effect timing is sustained.

The invention has been described above by means of a preferred embodiment. It should be noted that there are alternative ways and variations which are obvious to a skilled person in the art and can be implemented without deviating from the scope and spirit of the appended claims, e.g. the storage format and storage locations of the SMEs and PASs might substantially differ from the set-up of the device as depicted in FIG. 1, further types of PASs might be used and, in the field of cellular mobile communications, the invention may be adapted to the messaging format of the Enhanced Messaging Service (EMS) and the Multimedia Messaging Service (MMS).

1. A device for perceivably accentuating message elements of a message, wherein said message is composed of message elements chosen from a limited set of message elements, the device comprising:
means for defining and/or altering a set of Selected Message Elements (SMEs) containing at least one SME, wherein each SME is a message element from said limited set of message elements,
means for assigning a Perceivable Accentuation Signal (PAS) from a set of PASs to each of said SMEs in said set of SMEs,
means for searching said message for SMEs of said set of SMEs, and
means for generating the assigned PAS for each SME found in said message.

2. The device according to claim 1, characterised in that said set of PASs comprises optically and/or acoustically and/or haptically and/or olfactorily and/or thermally and/or electrically PASs.

3. The device according to claim 1, characterised in that said PASs in said set of PASs have different signal characteristics such as amplitudes and/or frequencies and/or durations and/or signal forms.

4. The device according to claim 1, characterised in that said message is a text message, that said message elements are characters or combinations thereof and that said means for searching said message for SMEs of said set of SMEs comprises a parser.

5. The device according to claim 1, characterised in that said set of SMEs and information on the PASs assigned to each SME in said set of SMEs are stored in said device.

6. The device according to claim 1, characterised in that said means for generating the assigned PAS for each SME found in said message comprises means for generating said assigned PASs for each SME found in the message sequentially and synchronised with the rendering velocity of the message and/or synchronised with the message perception velocity of the user of said device.

7. The device according to claim 6, characterised in that the device further comprises means for determining the message perception velocity of the user of said device.

8. The device according to claim 1, characterised in that said device is contained in a mobile phone that is operable in a mobile communications system and that said message is a message in the format of the Short Message Service (SMS).

9. The device according to claim 1, characterised in that said device is contained in a computer and that said message is an electronic mail (e-mail) message.

10. A method for the perceivable accentuation of message elements of a message, wherein said message is composed of message elements chosen from a limited set of message elements, comprising the following steps:
defining and/or altering a set of Selected Message Elements (SMEs) containing at least one SME, wherein each SME is a message element from said limited set of message elements and is assigned a Perceivable Accentuation Signal (PAS) from a set of PASs,
searching said message for SMEs of said set of SMEs, and
generating the assigned PAS for each SME found in the message.

11. The method according to claim 10, characterised in that said set of PASs comprises optically and/or acoustically and/or haptically and/or olfactorily and/or thermally and/or electrically PASs.

12. The method according to claim 10, characterised in that said PASs in said set of PASs have different signal characteristics such as amplitudes and/or frequencies and/or durations and/or signal forms.

13. The method according to claim 10, characterised in that said message is a text message, that said message elements are characters or combinations thereof and that said step of searching said message for SMEs of said set of SMEs comprises the step of parsing said message.

14. The method according to claim 10, characterised in that said set of SMEs and information on the PASs assigned to each SME in said set of SMEs are stored.

15. The method according to claim 10, characterised in that said assigned PASs for each SME found in the message are generated sequentially and synchronised with the rendering velocity of the message and/or synchronised with the message perception velocity of the user of said method.

16. The method according to claim 15, characterised in that the method further comprises the step of determining the message perception velocity of the user of said method.

17. A computer program product directly loadable into the internal memory of a digital computer, comprising software code portions for performing the method steps of claim 10 when said product is run on a computer.
